(19) United States
(12) Patent Application Publication
(10) Pub. No.: US 2014/0182698 A1
(43) Pub. Date: Jul. 3, 2014

(54) Universal Bag Connector

(71) Applicant: Carrier Corporation, Famington, CT (US)

(72) Inventors: Joseph J. Scordato, Beloit, WI (US); Timothy R. Whitney, Beloit, WI (US); Tom S. Christopherson, Beloit, WI (US)

(73) Assignee: Carrier Corporation, Famington, CT (US)

(21) Appl. No.: 14/122,340

(22) PCT Filed: May 15, 2012
(86) PCT No.: PCT/US2012/037909

§ 371 Date: Nov. 26, 2013

Related U.S. Application Data
(60) Provisional application No. 61/492,515, filed on Jun. 2, 2011.

(51) Int. Cl. F16L 41/02; B67D 7/78

(52) U.S. Cl. CPC F16L 41/02; B67D 7/78
USPC 137/15.01; 137/561 A

(57) ABSTRACT

A universal connector (100) is disclosed for use in the food industry to connect a food product dispenser to a food product source. The connector (160) has an evacuation tube (120) having a dispensing port (140), intake manifold (128), a grommet interface section (154), and an inner cylindrical chamber (136) disposed within the evacuation tube (120). The connector (100) has a grommet (110) in surrounding relation with the grommet interface (154) of the evacuation tube (120). The connector (100) capable of creating a connection between the food product source to facilitate evacuation of the contents of the food product source.

### CROSS-REFERENCE TO RELATED APPLICATION

Reference is made to and this application claims priority from and the benefit of U.S. Provisional Application Ser. No. 61/492,515, filed Jun. 2, 2011, and entitled UNIVERSAL BAG CONNECTOR, which application is incorporated herein in its entirety by reference.

### BACKGROUND OF THE INVENTION

The subject matter disclosed herein relates generally to connectors used to evacuate liquid and food products contained within storage containers, and specifically to a universal connector to evacuate storage bags of various types and sizes.

In the food service industry, food products are typically contained in pre-filled plastic bags. Types of food products that may be contained in a plastic bag includes juice, juice concentrate, milk, cream, condiments, ice cream mix, milkshake mix, soups, etc.

The filler of the bag often attaches a connection to allow dispensing equipment to feed from the bag. In some cases the connection is a fitment that may lock onto an evacuation mechanism, or a port, attached to the dispensing equipment. In other cases, the connection includes a full tube assembly, which may have a quick disconnect fitting for attaching to the dispensing equipment, and which acts as a port through which food product is dispensed from the bag.

Many types of connections, including fitments, connection locations and shapes of bags are used in the food service industry. These different connections require specific connectors to connect to a food product dispenser. The food service industry uses many different types of dispensing equipment, which have various mechanisms to connect to a bag and various pump and flow rate requirements to efficiently dispense food products from bags. Consequently, it necessary for designers of dispensing equipment to custom design specific connectors for use with specific bags depending upon bag size, tube size and port location.

### BRIEF SUMMARY OF THE INVENTION

A universal connector is provided to interface between a variety of food product sources and food product dispensers. Additionally, a universal connection system is provided to interface between a variety of food product sources and food product dispensers. In addition to universal application, the disclosed connector and connector system may allow for improved performance in evacuation of the product from the product source and in product flow rate.

According to one embodiment, the connector includes an evacuation tube comprising a dispensing port, an intake manifold comprising at least one intake port, a grommet interface disposed along an outer surface of the evacuation tube and situated between the dispensing port and the intake manifold of the evacuation tube, and an inner chamber disposed between a first end and a second end of the evacuation tube and forming a pathway between the intake manifold and the dispensing port to permit food product to be evacuated from the food product source to the dispenser; and a grommet in surrounding relation with the grommet interface of the evacuation tube, the grommet capable of forming a seal with a fitment of a food product source.

In another embodiment, a connector system is provided. The connection system includes an evacuation tube comprising a dispensing port, an intake manifold comprising at least one intake port, a grommet interface disposed along an outer surface of the evacuation tube and situated between the dispensing port and the intake manifold of the evacuation tube, and an inner chamber disposed between the first end and second end of the evacuation tube and forming a pathway between the intake manifold and the dispensing port to permit food product to be evacuated from the food product source to the dispenser; a grommet in surrounding relation with the grommet interface of the evacuation tube, the grommet capable of forming a seal with a fitment of a food product source; and an attachment ring comprising an inner chamber having the evacuation tube and grommet insertable within the inner chamber to form a seal between the attachment ring and grommet, wherein attachment of the connector system to a food product source allows food product to be evacuated from the food product source to a food product dispenser.

A method for connecting a food product source to a food product dispenser is also provided. The method includes providing a connector comprising an evacuation tube and an elastic grommet, providing a ring affixed to a food product source, inserting the elastic grommet into an opening of the ring of the food product source, inserting the evacuation tube into an opening of the elastic grommet to create a releasable seal between the elastic grommet and the ring, inserting an intake manifold of the evacuation tube into the food product source, and connecting the evacuation tube to a dispenser for evacuating food product from the food product source through the intake manifold toward the dispenser.

### BRIEF DESCRIPTION OF THE DRAWINGS

For a further understanding of the disclosure, reference will be made to the following detailed description which is to be read in connection with the accompanying drawing, wherein:

FIG. 1A depicts a side view of an exemplary embodiment of the universal connector.

FIG. 1B depicts a side perspective of an exemplary embodiment of the universal connector interfaced between a food product source and a dispenser.

FIG. 2 depicts an exploded side view of the universal connector of FIG. 1.

FIG. 3 depicts a cross sectional view of the universal connector of FIG. 1.

FIG. 4A depicts a side perspective view of an exemplary embodiment of the grommet inserted into a fitment.

FIG. 4B represents a cross-sectional view along line 9-9 in FIG. 4A.

FIG. 4C represents a cross sectional view of another exemplary embodiment of the grommet inserted into a fitment.

FIG. 4D is a cross-sectional view along line 6-6 in FIG. 2.

FIG. 5 depicts a cut-away side perspective view of an exemplary embodiment of the grommet inserted into a fitment.

FIG. 6A depicts a side perspective view of an exemplary embodiment of the universal connector interfaced with a food product source.

FIG. 6B is a cross-sectional view along line 6B-6B in FIG. 6A.

FIG. 7 depicts a cut-away side perspective view of another exemplary embodiment of the universal connector interfaced with a food product source.

FIG. 8 depicts a side perspective view of the universal connector, wherein the container and fitment is cutaway to display the universal connector contained therein.

FIG. 9 is a side view of an exemplary embodiment of the attachment ring.

FIG. 10 is a cross-sectional view along line 10-10 of FIG. 9.

FIG. 11 depicts a rear view of an exemplary embodiment of the attachment ring.

FIG. 12 is a front view of an exemplary embodiment of the attachment ring.

FIG. 13 is a side perspective view of an exemplary embodiment of the attachment ring affixed to a container.

FIG. 14 is a side perspective view of an exemplary embodiment of the connector inserted into the attachment ring that is affixed to a container.

FIG. 15 depicts a cross-sectional view along line 15-15 in FIG. 14.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

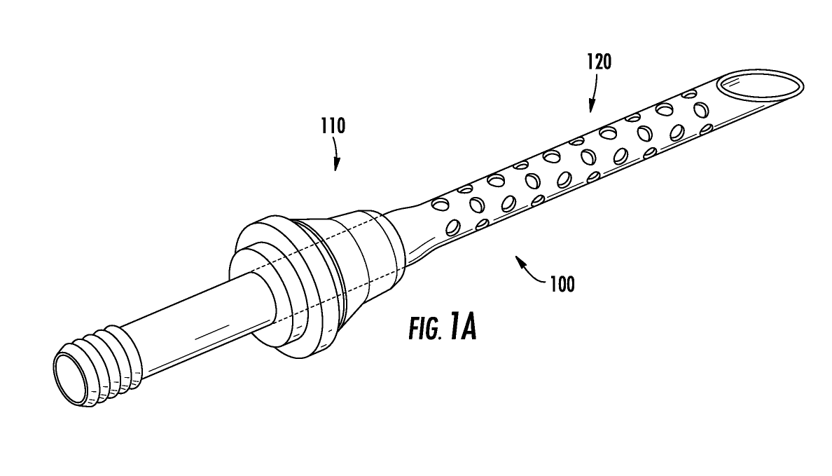

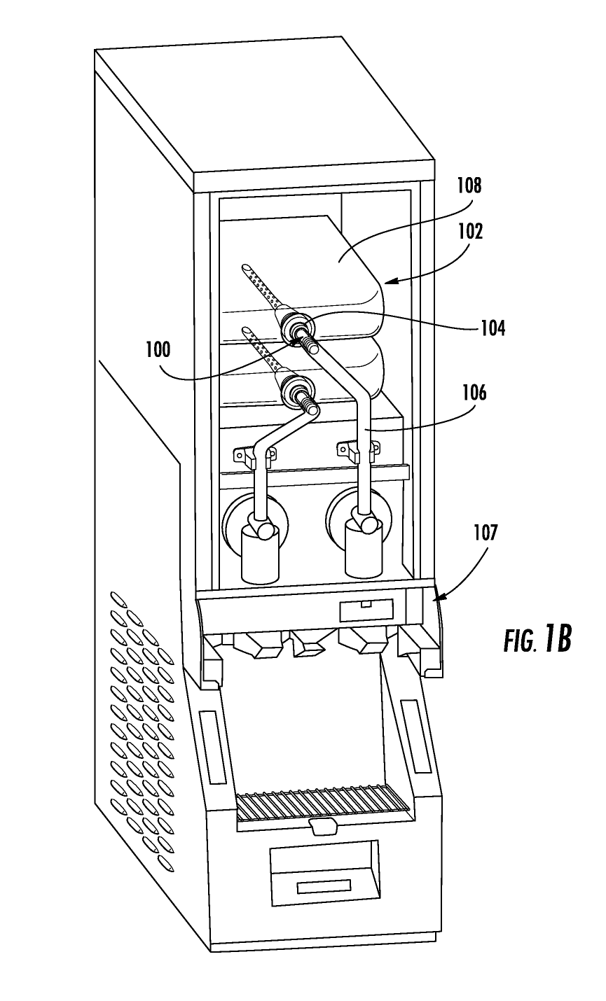

FIG. 1A depicts an exemplary embodiment of the connector 100 in an assembled state. Connector 100 has an evacuation tube 120 and a grommet 110 surrounding a portion of the evacuation tube 120.

FIG. 1B depicts connector 100 interfaced between a dispenser 107 and a fitment 104 of a food product source 102. Food product source 102 is connected to a fluid delivery line 106 of a dispenser 107 via connector 100. Dispensers 107 have a variety of components to dispense food products for gravity or pumped dispensing. Dispensers 107 also have a variety of connections that may be supplemented for fluid delivery line 106.

Food product sources 102 include sealed prefilled bags and other containers having food product contained within the walls 108 of the bag. Suppliers of food product sources 102 attach, typically via a heat seal, a fitment 104 onto the wall 108. The types of fitments include raised rings, nozzles and sealing rings, and may include locking mechanisms, threaded connections, grooves and other quick disconnect features. Regardless of the type of fitment used by the supplier, each fitment 104 has an inner tube, or port, through which food product is dispensed from food product source 102. Food product sources 102 are prepackaged by suppliers, and the supplier determines the size and shape of the food product course, length and width.

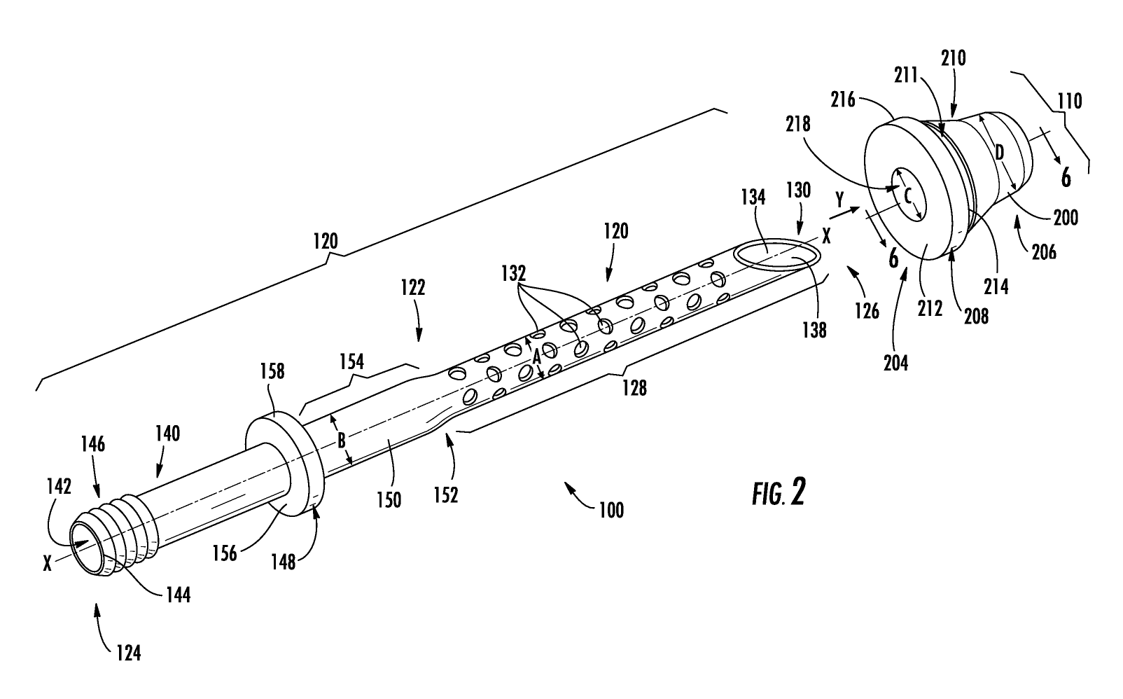

FIG. 2 is an exploded view of connector 100 of FIG. 1A. In an exemplary embodiment, evacuation tube 120 is made of stainless steel. In other embodiments, evacuation tube 120 is made of hardened plastic or other metal alloys. In some embodiments, evacuation tube 120 is capable of being sterilized and reused.

In an exemplary embodiment, grommet 110 is made of synthetic rubber. In other embodiments, grommet 110 is made of natural rubber, or other synthetic elastic materials. In some embodiments, grommet 110 is capable of being sterilized and reused.

Evacuation tube 120 has a tubular body 122 disposed along a longitudinal axis x-x. Tubular body 122 has a first end 124 and a second end 126. Beginning near second end 126 and extending toward first end 124, an intake manifold 128 is disposed along tubular body 122. In an exemplary embodiment, intake manifold 128 is generally defined by a plurality of intake ports 132 disposed along the longitudinal axis of the tubular body 122 for drawing food product within the evacuation tube 120. In other embodiments, tubular body 122 does not include a plurality of intake ports.

The size and shape of the intake ports 132 is capable of variation based on the viscosity of the food product to be dispensed. For example, more viscous food products may require larger intake ports and/or differently shaped intake ports 132.

In an exemplary embodiment, the longitudinal dimension of intake manifold 128 along line x-x is capable of being sized to extend the length of a food product source 102. In other embodiments, the intake manifold 128 is modified to extend only a portion of the entire length of a food product source 102. The longitudinal length of the intake manifold 128 permits food product source 102 to be held in an upright position to prevent folding, and thereby promote efficient evacuation of the contents of the food product source.

Evacuation tube 120 includes a tip 130 located near the second end 126 of the evacuation tube 120. In an exemplary embodiment, tip 130 is shaped to pierce a wall 108 of a food product source 102, and the edge 134 of tip 130 generally defines an intake port 138 for drawing food product within the inner chamber 136. The diameter of the intake port 138 may be modified depending on the viscosity of the food product to be dispensed. Tip 130 is particularly useful connecting to food product sources in which wall 108 (FIG. 1B) must be pierced before evacuating the food product. In other embodiments, particularly those used for engaging food product sources that do not require the wall to be pierced, tip 130 is rounded, or blunt.

Tubular body 122 of evacuation tube 120 has a dispensing port 140 having an opening for dispensing food product drawn within the evacuation tube 120. In an exemplary embodiment as depicted in FIG. 2, the dispensing port 140 begins at first end 124 and extends toward second end 126. In an exemplary embodiment, dispensing port 140 has an interface 146 for connecting to a fluid delivery line 108 of a dispenser. In an exemplary embodiment, interface 146 is a series of ridges that form a compression fitting with a fluid delivery line 108, such as an elastic tube. In other embodiments, interface 146 may be notches, ribbing, or any other shapes to form a releasable fitting with a fluid delivery line 108, as would be known by those of skill in the art.

One of skill in the art would understand that the length of dispensing port 140 along the longitudinal axis x-x, and the circumference of the dispensing port, may be modified depending on the dimensions of a fluid delivery line 106 or other connection to a dispenser.

Dispensing port 140 has an edge 144 located near the first end 124. Edge 144 generally defines an opening 142 having a diameter for dispensing food product drawn within the evacuation tube 120. The diameter of the opening 142 may be modified depending on the viscosity of the food product to be dispensed and the flow rate requirements of the dispenser.

In this regard, once intake manifold 128 of connector 100 is inserted into a food product source 102 and the dispensing port 140 of connector 100 is connected to a dispenser 107, the dispenser creates a force to draw food product through the intake manifold 128 and/or intake port 138 into the evacuation tube 120 toward the first end 124, and the food product exits opening 142 into the dispenser 107.

Tubular body 122 has an external surface 150. In an exemplary embodiment, a flange 148 is molded as part of external surface 150. In other embodiments, flange 148 is attached to external surface 150 through welding, a compression fitting or other known methods to affix flange 148 to external surface 150. In an exemplary embodiment, flange 148 is positioned between the first end 124 and second end 126 along external surface 150 of tubular body 122. Flange 148 has a first surface 156 facing the first end 124 and a second surface facing the second end 126.

In an exemplary embodiment, intake manifold 128 of tubular body 122 has an external diameter A. Tubular body 122 has a bevel 152 that outwardly extends from intake manifold 128 toward first end 124. A grommet interface 154 section of the tubular body 122 is located between the bevel 152 and flange 148. In an exemplary embodiment, grommet interface 154 section has a diameter B that is greater than diameter A of the manifold. In other embodiments, diameters A and B are the same.

In an exemplary embodiment, such as depicted in FIG. 2, a flange 208 is located a first end 204 of the grommet body 200 and extends outwardly from the grommet body 200. Flange 208 has a first surface 212 facing first end 204 and a second surface 214 facing second end 206. Flange 208 also has an outer surface 216. In an exemplary embodiment, outer surface 216 is smooth. In other embodiments, outer surface 216 is collared to form an inner detent between two raised ridges. Other embodiments of grommet have multiple flanges for securing the connector to a fitment on a food product source.

In an exemplary embodiment, grommet 110 has a retaining ridge 210 disposed on the grommet body 200. A detent 211 is disposed on the grommet body 200 between flange 208 and retaining ridge 210. The retaining ridge 210 may be spaced at varying distances from the flange 208 to the detent 211. The detent 211 is adapted to receive a ringed edge of a fitment 104, between the flange 208 and the retaining ridge 210, and the retaining ridge 210 locks the fitment onto the grommet 110. In other embodiments of the grommet, the grommet body 200 does not have a retaining ridge or detent disposed on the grommet body 200.

To assemble connector 100, tip 130 of evacuation tube 120 is inserted into first opening 218 of grommet 110 in direction Y. Evacuation tube 120 slides along axis x-x through opening 218 of grommet 110 until second surface 158 of flange 148 contacts first surface 212 of flange 208.

Diameter C of opening 218 is slightly larger than diameter A of intake manifold 128, which permits intake manifold 128 to readily slide along axis x-x in direction Y through opening 218 of grommet 110.

In another embodiment, diameter C of opening 218 is the same as or smaller than diameter B of grommet interface 154. During assembly, as tubular body 122 slides along axis x-x in direction Y through grommet 110, bevel 152 biases inner chamber 202 of grommet 110 to expand. More particularly, in an assembled state, inner chamber 202 surrounds grommet interface 154 to form a compression fitting between grommet 110 and evacuation tube 120.

FIG. 3 is a cross-sectional view of one embodiment of the evacuation tube 120. Tubular body 122 has an inner surface 302 surrounding inner chamber 136 that extends from first end 124 to second end 126. Food product enters through the intake ports 132 and intake port 138 into the inner chamber 136. Inner chamber 136 acts as a passageway through which food product travels toward the dispensing port 140 and the dispenser.

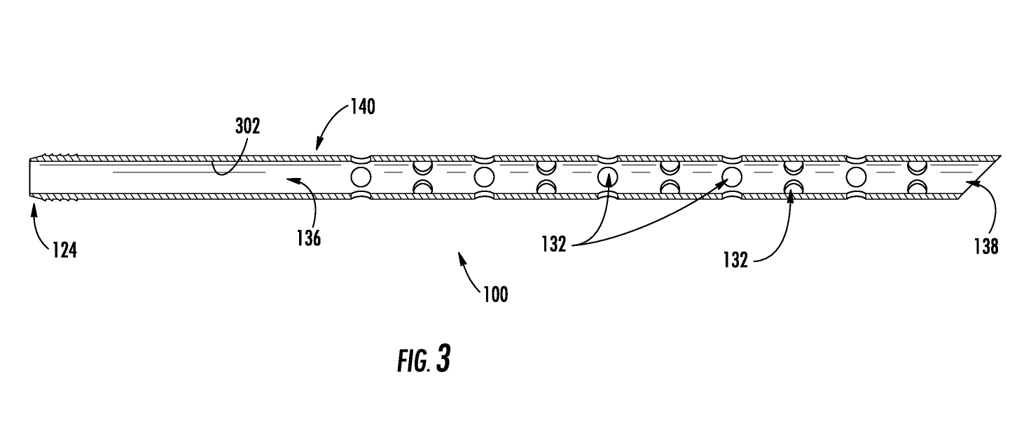

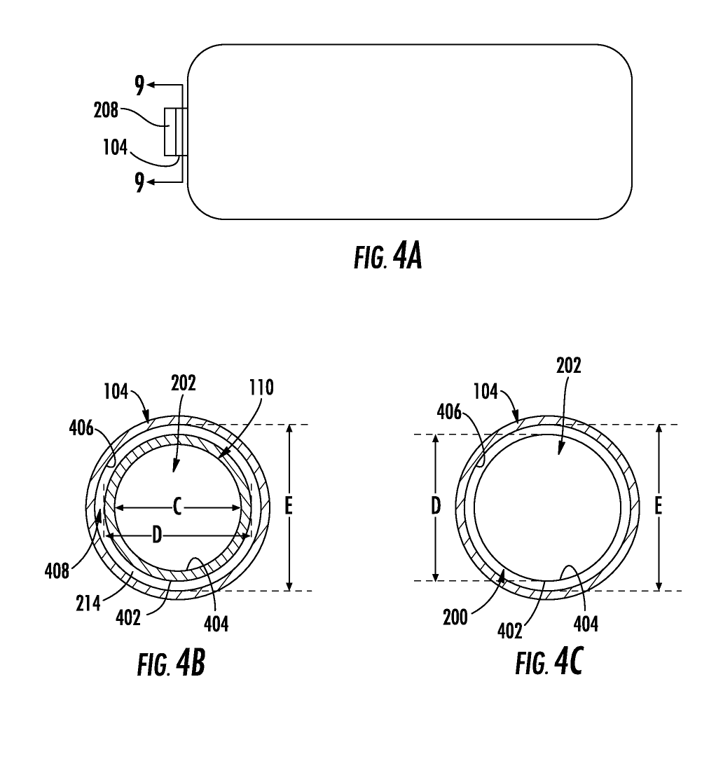

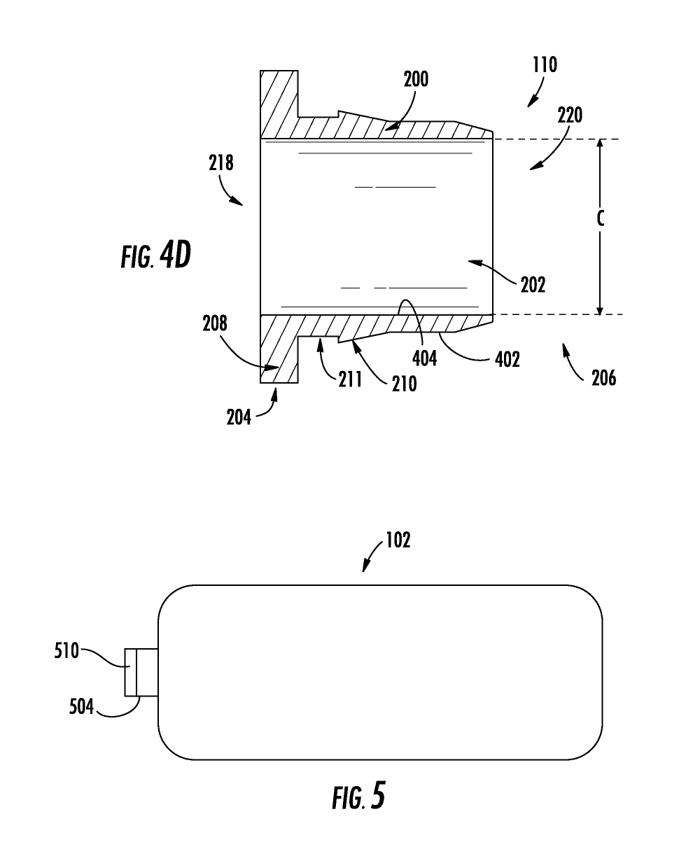

FIG. 4A illustrates an exemplary embodiment of a grommet 110 inserted into a fitment 104. FIG. 4B represents a cross-sectional view along line a-a in FIG. 4A. Grommet body 200 has an outer surface 402 and an inner surface 404. Inner surface 404 surrounds inner chamber 202, and has a diameter C.

Outer surface 402 has a diameter D. In a state where grommet 110 is inserted into a fitment 104, outer surface 402 is in close proximity to inner surface 406 of fitment 104. Inner surface 406 of fitment 104 has a diameter E defining an inner chamber 408 of the fitment. In at an exemplary embodiment, diameter D is less than diameter E. Insertion of the grommet 110 into the inner chamber 408 of the fitment 104 is readily achieved. Insertion of the evacuation tube 120 into the first opening 218 of grommet biases outer surface 402 of grommet body 200 toward inner surface 406 of fitment 104 forming a seal between outer surface 402 and inner surface 406.

FIG. 4C is a cross-sectional view of another embodiment of grommet 110 inserted into a fitment 104. In this embodiment, diameter D of outer surface 402 is the same as or greater than diameter E of inner surface 206. In these embodiments, insertion of grommet body 200 into the inner chamber 408 of the fitment 104 requires the use of force to seat grommet 110 within the fitment 104 and form a seal between outer surface 402 of grommet body 200 and inner surface 406 of fitment 104. Insertion of an evacuation tube 120 into the first opening 218 of grommet biases and compresses the outer surface 402 of the grommet body 200 against the inner surface of the fitment 104, and biases and compresses the inner surface 404 toward the inner surface of the fitment 104 to create a seal.

FIG. 4D is a cross-sectional view of the grommet body 200 along line 6-6 in FIG. 2. As shown, grommet 110 has an internal surface 404 generally defining an internal chamber 202 extending from the first end 204 to second end 206 and creating a passageway between first opening 218 and second opening 220. The detent 211 is also shown between the flange 208 and retaining ridge 210.

FIG. 5 is a side view of another embodiment of a grommet 510 inserted into an inner chamber of a fitment 504 of a food product source 102. As discussed herein, grommet 510 may be modified to fit within a specified fitment 504. Different types of fitments have varying dimensions of inner chambers, such as length, width and shape. Embodiments of the disclosed grommets are modified to fit within the fitments.

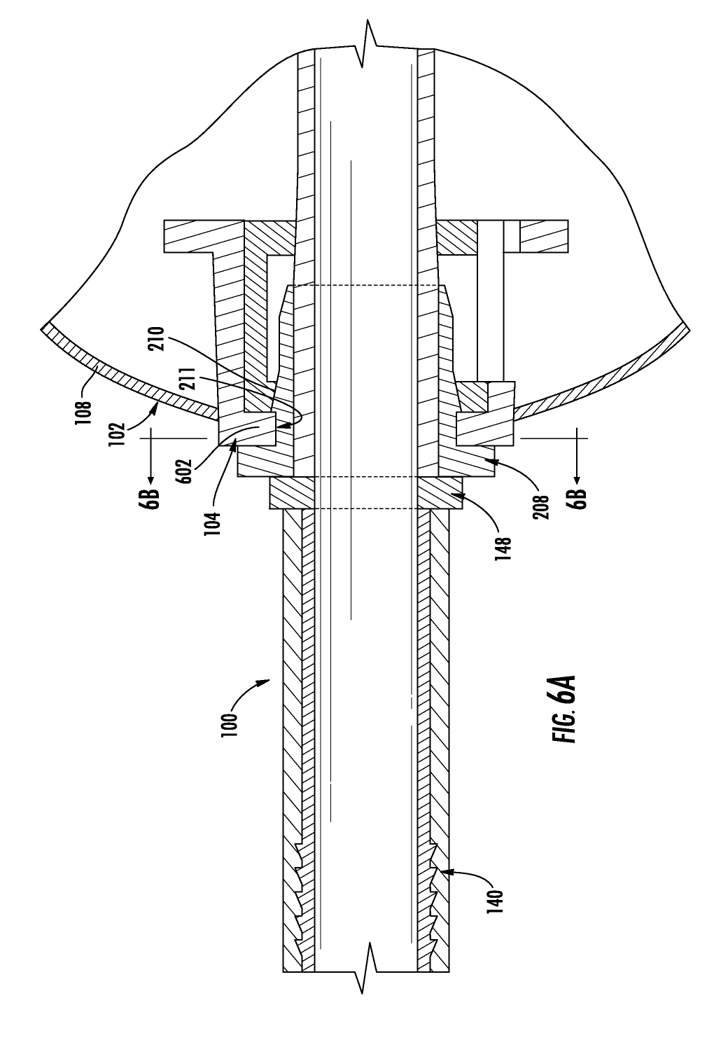

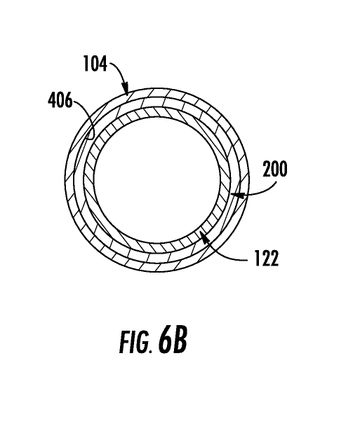

FIG. 6A is a view of an embodiment of the connector 100 interfaced with the fitment 104 of food product source 102. Portions of the wall 108 and fitment 104 are cut-away to show connector 100 positioned therein. As shown, fitment 104 has a ringed edge 602 that fits within detent 211. Detent 211 retains the ring 602 between the flange 208 and retaining ridge 210 in a locked position. In an exemplary embodiment, removal of the evacuation tube from the grommet causes the grommet body to decompress relative to the fitment and the grommet may be removed from the fitment.

FIG. 6B is a cross-sectional view along line 6B-6B in FIG. 6A. The tubular body 122 of the evacuation tube is shown inserted into the grommet body 200. As described above, assembly of the connector 100 biases grommet body 200 toward the inner surface 406 of the fitment 104 to create a seal between the fitment 104 and grommet body 200.

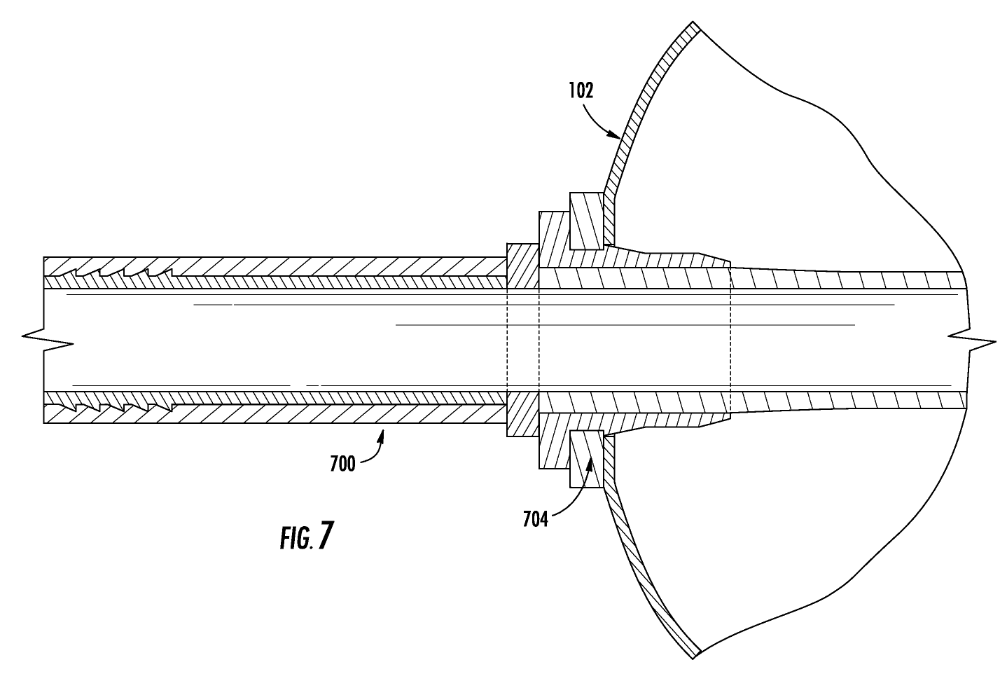

FIG. 7 is a side view of another embodiment of a connector 700 inserted into a fitment 704 of a food product source 102.

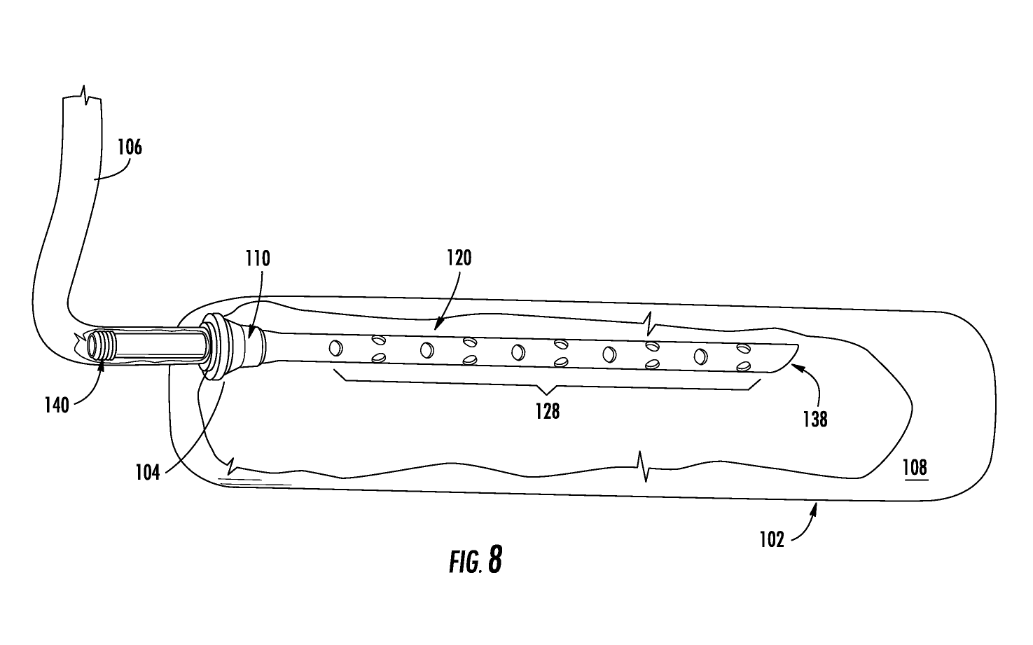

FIG. 8 is a side view of a connector 100 interfaced with a food product source 102 having the wall 108 cut-away to show the evacuation tube 120 enclosed therein. The delivery line 106 is also cut-away to show the dispensing port 140 disposed therein. Once the food product is emptied from the source 102, the connector 100 is removed from the fitment 104. In some embodiments, grommet 110 and evacuation tube 120 are separated, sterilized and reused.

As shown in FIG. 8, when connector 100 is connected to a food product source 102 and a fluid delivery line 106, food product is drawn through intake manifold 128 and intake port 138 into the evacuation tube 120 toward the dispensing port 140 and into the fluid delivery line 106.

Some food product sources 102 contain fitments 104 located along the wall 108 in a position not easily accessed by a food product dispenser. Supplier provided fitments may also contain mechanisms or properties preventing insertion of a connector according to the disclosed embodiments.

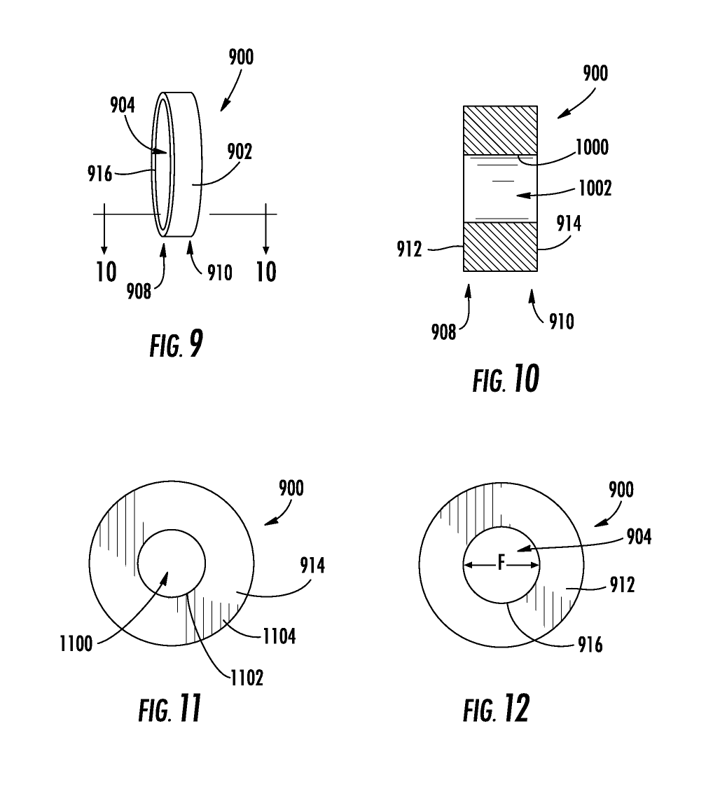

FIG. 9 is a side view of an attachment ring 900 to attach to a food product source in the situations where the fitment is not suitably located or dimensioned. Attachment ring 900 contains an adhesive for attachment to a food product source. Attachment ring 900 is also provided to match the dimensions of the connector to provide a secure connection between the food product source, ring, connector and food dispenser.

In an exemplary embodiment, attachment ring 900 is made of plastic. In other embodiments, attachment ring 900 is made of metal alloys. In some embodiments, attachment ring 900 is disposable.

Attachment ring 900 has a first end 908, second end 910 and a body 902 extending there between. In an exemplary embodiment, body 902 is ringed and has a ringed edge 916 generally defining an opening 904, proximate first end 908. In other embodiments, body 902 may be elongated and/or have a flange extending outwardly from the body creating a larger surface area to attached the ring to the food product source.

FIG. 10 represents a cross-sectional view of the attachment ring 900 along line z-z in FIG. 9. Inner surface 1000 generally defines an inner chamber 1002, which extends from the first end 908 to the second end 910 creating a passageway within the ring 900. Body 902 has a first surface 912 facing first end 908 and a second surface 914 facing second end 910.

FIG. 11 is a view facing the second surface 914 of the attachment ring 900. Second surface 914 is defined between an outer ring 1104 and an inner ring 1102. In an exemplary embodiment, an adhesive is applied to second surface 914 for adhering attachment ring to the wall of a food product container. The types of adhesives include double sided tape, glue, and epoxy resins.

Inner ring 1102 generally defines an opening 1100 along the second end, which leads to the inner chamber 1002 as shown in FIG. 10.

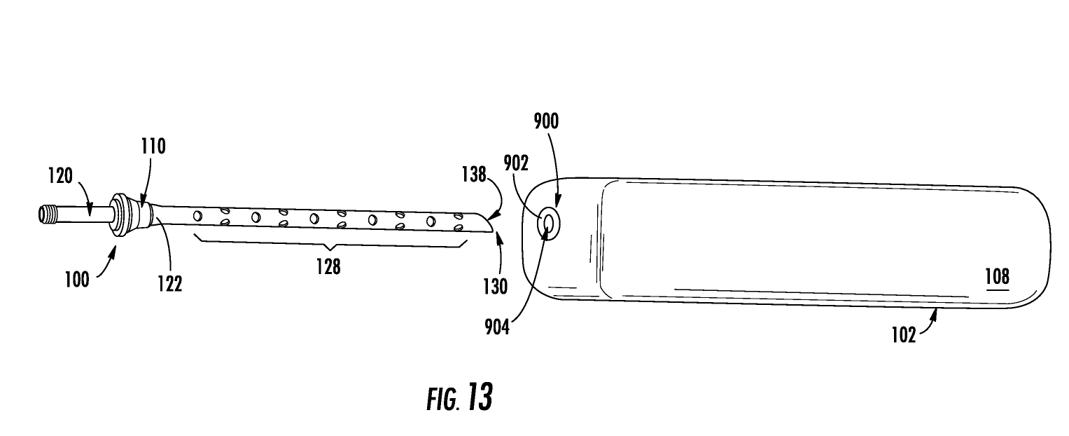

FIG. 12 is a view facing the first surface 912. Ringed edge 916 has a diameter F and defines opening 904, which leads to the inner chamber 1002 as shown in FIG. 10.

As discussed above in FIG. 2, a grommet body 200 has a diameter D (FIG. 2). In an exemplary embodiment, diameter D of the grommet is greater than diameter F of the attachment ring 900, which allows a grommet body 200 to be readily inserted into the inner chamber 1002 of the attachment ring 900. Insertion of an evacuation tube 120 into the first opening 218 of grommet 110 biases and compresses the grommet body 200 against the attachment ring 900 to create a seal.

In other embodiments, diameter D is the same as or greater than diameter F. In these embodiments, insertion of grommet 110 into the inner chamber 1002 requires the use of force to seat grommet 110 within the attachment ring 900. Insertion of an evacuation tube 120 into the first opening 218 of grommet 110 biases and compresses the grommet body 200 against the attachment ring 900 to create a seal.

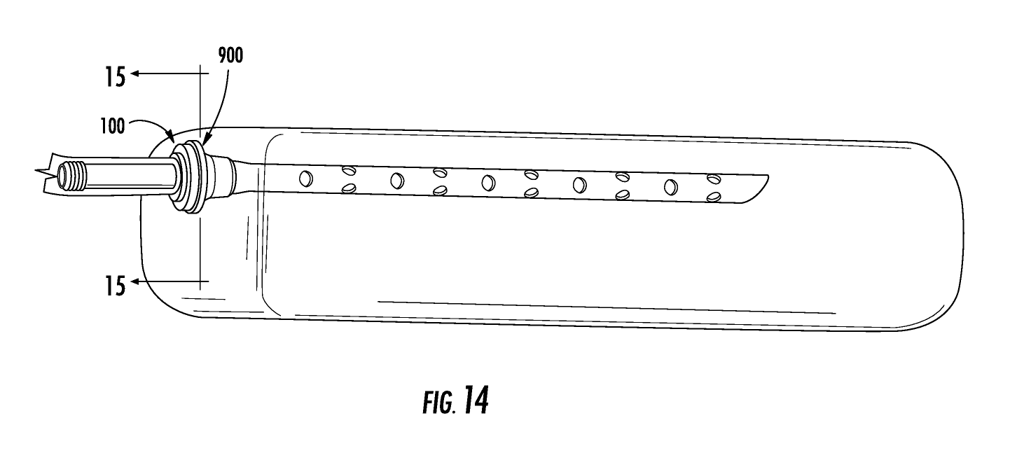

FIG. 13 depicts an attachment ring 900 affixed to a wall 108 of a food product source 102 and a connector 100 ready to be inserted into opening 904. Attachment of the ring 900 to the food product source 102 may be made at any location along the wall 108 of the food product source. During insertion of connector 100 into opening 904, the tip 130 of the connector 100 pierces the wall 108 of the food product source and permits the tubular body 122, including intake manifold 128 and intake port 138, to be inserted into the food product source 102 for evacuating the food product. Once the food product is emptied from the source 102, the connector 100 is removed from the attachment ring 900. In an exemplary embodiment, grommet 110 and evacuation tube 120 are separated, sterilized and reused. Attachment ring 900 is disposed of along with the food product source.

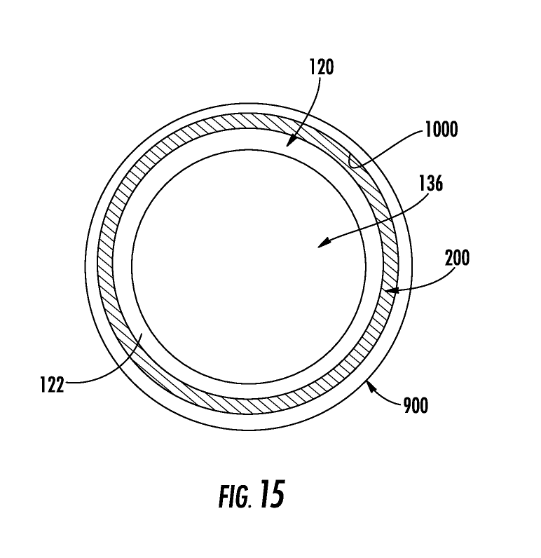

FIG. 14 illustrates a connector 100 inserted into an embodiment of attachment ring 900. FIG. 15 is a cross-sectional view along line d-d of FIG. 14. Tubular body 122 of the evacuation tube 120 is shown inserted into the inner chamber of the grommet body 200. In the assembled state, tubular body 122 biases grommet body 200 toward the inner surface 1000 of the attachment ring 900 and creates a seal there between. In this assembled state, food product passes from the food source, into the inner chamber 136 of the tubular body, and through the dispensing port 140 (not shown) into the food dispenser.

The terminology used herein is for the purpose of description, not limitation. Specific structural and functional details disclosed herein are not to be interpreted as limiting, but merely as basis for teaching one skilled in the art to employ the present invention. Those skilled in the art will also recognize the equivalents that may be substituted for elements described with reference to the exemplary embodiments disclosed herein without departing from the scope of the present invention.

While the present invention has been particularly shown and described with reference to the exemplary embodiments as illustrated in the drawing, it will be recognized by those skilled in the art that various modifications may be made without departing from the spirit and scope of the invention. Therefore, it is intended that the present disclosure not be limited to the particular embodiment(s) disclosed as, but that the disclosure will include all embodiments falling within the scope of the appended claims.

What is claimed:

1. A connector for use in the food industry to interface between a fitment of a food product source and a food product dispenser, comprising:
an evacuation tube having a first end and a second end including
a dispensing port;
an intake manifold comprising at least one intake port;
a grommet interface disposed along an outer surface of the evacuation tube and situated between the dispensing port and the intake manifold; and
an inner chamber disposed between the first end and second end of the evacuation tube and forming a pathway between the intake manifold and the dispensing port to permit food product to be evacuated from the food product source to the dispenser; and
a grommet in surrounding relation with the grommet interface of the evacuation tube, the grommet capable of forming a seal with a fitment of a food product source.

2. The connector of claim 1, wherein the evacuation tube is made of stainless steel.

3. The connector of claim 1, wherein the grommet is made of an elastic material.

4. The connector of claim 1, wherein the evacuation tube further comprises a flange adapted to retain grommet in a surrounding relation with grommet interface.

5. The connector of claim 1, wherein the intake manifold further comprises a plurality of intake ports.

6. The connector of claim 1, further comprising a fitment releasably sealed to the grommet.

7. The connector of claim 1, wherein the grommet further comprises a detent and a retaining ridge, the detent capable of receiving a fitment therein and the retaining ridge capable of locking a fitment onto the grommet.

8. The connector of claim 1, wherein the dispensing port is adapted to releasably attach to a food product dispenser.

9. A connection system for use in the food industry to interface between a food product source and a food product dispenser, comprising:
an evacuation tube including
a dispensing port;
an intake manifold comprising at least one intake port;
a grommet interface disposed along an outer surface of the evacuation tube and situated between the dispensing port and the intake manifold; and
an inner chamber disposed between the first end and second end of the evacuation tube and forming a pathway between the intake manifold and the dispensing port to permit food product to be evacuated from the food product source to the dispenser,
a grommet in surrounding relation with the grommet interface of the evacuation tube, the grommet capable of forming a seal with a fitment of a food product source, and
an attachment ring comprising an inner chamber having the evacuation tube and grommet insertable within inner chamber to form a seal between the attachment ring and grommet,
wherein attachment of the connector system to a food product source allows food product to be evacuated from the food product source to a food product dispenser.

10. The connector of claim 9, wherein the evacuation tube is made of stainless steel.

11. The connector of claim 9, wherein the grommet is made of an elastic material.

12. The connector of claim 9, wherein the evacuation further comprises a means for retaining grommet in a surrounding relation with grommet interface.

13. The connector of claim 9, wherein the intake manifold further comprises a plurality of intake ports.

14. The connector of claim 9, wherein the attachment ring further comprises an adhesive disposed on a side of the attachment ring to affix the attachment ring to a food product source.

15. The connector of claim 9, wherein the dispensing port comprises a means for releasably attaching to a food product dispenser.

16. The connector of claim 9, wherein the grommet comprises a means for retaining the attachment ring on the grommet.

17. A method for connecting a food product dispenser to a food product source, the steps comprising:
providing a connector comprising an evacuation tube and an elastic grommet,
providing a ring affixed to a food product source,
inserting the elastic grommet into an opening of the ring of the food product source,
inserting the evacuation tube into an opening of the elastic grommet to create a releasable seal between the elastic grommet and the ring,
inserting an intake manifold of the evacuation tube into the food product source, and
connecting the evacuation tube to a dispenser for evacuating food product from the food product source through the intake manifold toward the dispenser.

18. The method of claim 17, wherein the evacuation tube comprises
a dispensing port disposed approximate a first end of the evacuation tube;
an intake manifold comprising at least one intake port disposed proximate a second end of the evacuation tube;
a grommet interface disposed along an outer surface of the evacuation tube and situated between the first and second end of the evacuation tube; and
an inner chamber disposed between the first end and second end of the evacuation tube and forming a pathway between the intake manifold and the dispensing port to permit food product to be evacuated from the food product source to the dispenser.

19. The method of claim 18, wherein the grommet is in surrounding relation with the grommet interface of the evacuation tube.

20. The method of claim 17, further comprising retaining the ring on the grommet.
